(19) United States
(12) Patent Application Publication
(10) Pub. No.: US 2015/0327197 A1
(43) Pub. Date: Nov. 12, 2015

(54) METHOD AND APPARATUSES FOR ADJUSTING TIME, COMPUTER-READABLE STORAGE MEDIA AND A COMPUTER PROGRAM PRODUCT

(71) Applicant: Klaus Kenneth Gustav ANDERSON, Paimio (FI)

(72) Inventor: Klaus Kenneth Gustav ANDERSON, Paimio (FI)

(73) Assignee: NOKIA CORPORATION, Espoo (FI)

(21) Appl. No.: 14/411,358

(22) PCT Filed: Aug. 14, 2012
(86) PCT No.: PCT/CN2012/080088

§ 371 Date: Dec. 24, 2014

(51) Int. Cl. H04W 56/00; H04J 3/06

(52) U.S. Cl. CPC H04W 56/005; H04W 56/001; H04J 3/0661

(57) ABSTRACT

The embodiments of the present invention provide a method and apparatus for adjusting time, a computer-readable storage media and a computer program product. In an embodiment of the present invention, the method can comprise determining a time adjustment amount based on at least a history frame number for a cell, a history timestamp corresponding to the history frame number, a current frame number for the cell, and a current timestamp corresponding to the current frame number; and adjusting time on the mobile device based on the time adjustment amount. With the embodiments provided in the present invention, the time on the mobile device can be adjusted in a simply manner and thus the accuracy of the time is improved at a low cost.

### TECHNICAL FIELD

The exemplary and non-limiting embodiments of the present invention relate to the field of cellular network technologies, and more particularly, relate to a method and apparatuses for adjusting time, a computer-readable storage media and a computer program product.

### BACKGROUND

Nowadays, the mobile device such as mobile phone, PDA (Personal Digital Assistant), Tablet PC (Personal Computer) or the like is becoming an indispensable electrical device for people. Recently, it has provided more and more useful applications to users, wherein applications related to time, e.g. clock, calendar, timer, alarm, stopwatch, notes, reminders, and etc., are quite helpful. Usually, in the mobile device, a hardware called RTC (Real Time Clock) is used to provide a clock signal for using by other circuits to further provide applications related to time, for example, those mentioned hereinabove. However, it is well known that the RTC is not very accurate and thus the time on the mobile device may drift over time.

In prior art, there have been some time synchronization technologies already. For example, on IP (Internet Protocol) networks, a protocol known as Network Time Protocol is used for keeping the local clock in synchronization with a reference clock over a network connection. Additionally, a GPS (Global Position System) signal can also be used for time synchronization.

However, the Network Time Protocol is not applicable to the situation that the mobile device is not directly connected to the IP networks; whereas the mobile device directly connected to the IP networks for example via Wi-Fi has been restricted by the WLAN (Wireless Local Area Network) hotspot distribution. On the other hand, the GPS time synchronization will require additional GPS modules which increase the cost of the mobile device.

Therefore, there is a need for a new technical solution suitable for solving the problem in the art.

### SUMMARY OF THE INVENTION

To the end, in the present invention, there is provided a time adjustment solution to overcome or at least mitigate the problems in the prior art partly.

In a first aspect of the present invention, there is provided a method, comprising: determining a time adjustment amount based on at least a history frame number for a cell, a history timestamp corresponding to the history frame number, a current frame number for the cell, and a current timestamp corresponding to the current frame number; and adjusting time on the mobile device based on the time adjustment amount.

In an embodiment of the aspect, the determining a time adjustment amount can comprise: determining a time difference based on the history timestamp and the current timestamp; determining a theory frame number based on the time difference and the history frame number; and calculating the time adjustment amount based on the theory frame number and the current frame number.

In another embodiment of the aspect, the time on the mobile device can be adjusted if the time adjustment amount is larger than a minimum adjustment threshold.

In a further embodiment of the aspect, the time on the mobile device can be adjusted if the time adjustment amount is lower than the maximum adjustment threshold.

In a yet further embodiment of the aspect, the time on the mobile device can be adjusted when it receives a confirmation that a bigger time adjustment is allowed.

In a still further embodiment of the aspect, the time on the mobile device can be adjusted when it detects a ping-pong effect and it receives a confirmation that the time adjustment under the ping-pong effect is allowed.

In a still yet further embodiment of the aspect, wherein the time on the mobile device can be adjusted if a frequency of time adjustment is lower than a predetermined frequency threshold.

In another embodiment of the aspect, the time on the mobile device can be adjusted if the time adjustment amount indicates a forward time adjustment.

In further embodiment of the aspect, the method can be performed when the automatic time adjustment setting is enabled.

In a yet further embodiment of the aspect, the minimum adjustment threshold is a function of difference between the history timestamp and the current timestamp.

In a still yet further embodiment of the aspect, the history timestamp and the history frame number can be obtained at one or more of: when the mobile device is connected to a new cell; when the mobile device scans a base station; when a user of the mobile device adjusts the time manually; when a predetermined time is elapsed; when it detects a ping-pong effect; and when the history frame number for the cell is determined as invalid.

In a second aspect of the present invention, there is provided an apparatus comprising: at least one processor; and at least one memory including computer program code, the at least one memory and the computer program code configured to, with the at least one processor, cause the apparatus to at least: determine a time adjustment amount based on at least a history frame number for a cell, a history timestamp corresponding to the history frame number, a current frame number for the cell, and a current timestamp corresponding to the current frame number; and adjust time based on the time adjustment amount.

In a third aspect of the present invention, there is also provided an apparatus comprising: means for determining a time adjustment amount based on at least a history frame number for a cell, a history timestamp corresponding to the history frame number, a current frame number for the cell, and a current timestamp corresponding to the current frame number; and means for adjusting the time based on the time adjustment amount.

In a fourth aspect of the present invention, there is provided a computer-readable storage media having computer program code stored thereon, the computer program code configured to, when executed, cause an apparatus to perform actions in the method according to any one of embodiments of the first aspect.

In a fifth aspect of the present invention, there is provided a computer program product comprising a computer-readable storage media according to the fourth aspect.

With the embodiments provided in the present invention, the time on the mobile device can be adjusted in a simply manner and thus the accuracy of the time is improved at a low cost.

### BRIEF DESCRIPTION OF THE DRAWINGS

The above and other features of the present invention will become more apparent through detailed explanation on the embodiments as illustrated in the embodiments with reference to the accompanying drawings. Like reference numbers represent same or similar components throughout the accompanying drawings of the present invention, wherein:

FIG. 1 schematically illustrates a diagram of the various time segments in GSM system;

FIG. 2 schematically illustrates a flow chart of the method for adjusting time on a mobile device according to an embodiment of the present invention;

FIG. 3 schematically illustrates a flow chart of steps of determining a time adjustment amount according to an embodiment of the present invention;

FIG. 4 schematically illustrates a block diagram of an apparatus for adjusting time according to an embodiment of the present invention; and

FIG. 5 schematically illustrates a block diagram of an apparatus for adjusting time according to another embodiment of the present invention.

### DETAILED DESCRIPTION OF EMBODIMENTS

Hereinafter, a method and apparatuses for adjusting time, a computer-readable storage media and a computer program product as provided in the present invention will be described in detail through embodiments with reference to the accompanying drawings. It should be understood that these embodiments are presented only to enable those skilled in the art to better understand and implement the present invention, not intend for limiting the scope of the present invention in any manner.

It should be first noted that this invention is illustrated in particular sequences for performing the steps of the methods. However, these methods are not necessarily performed strictly according to the illustrated sequences, and they can be performed in reverse sequence or simultaneously based on natures of respective method steps. Beside, the indefinite article “a/an” as used herein does not exclude a plurality of such steps, units, devices, and objects, and etc.

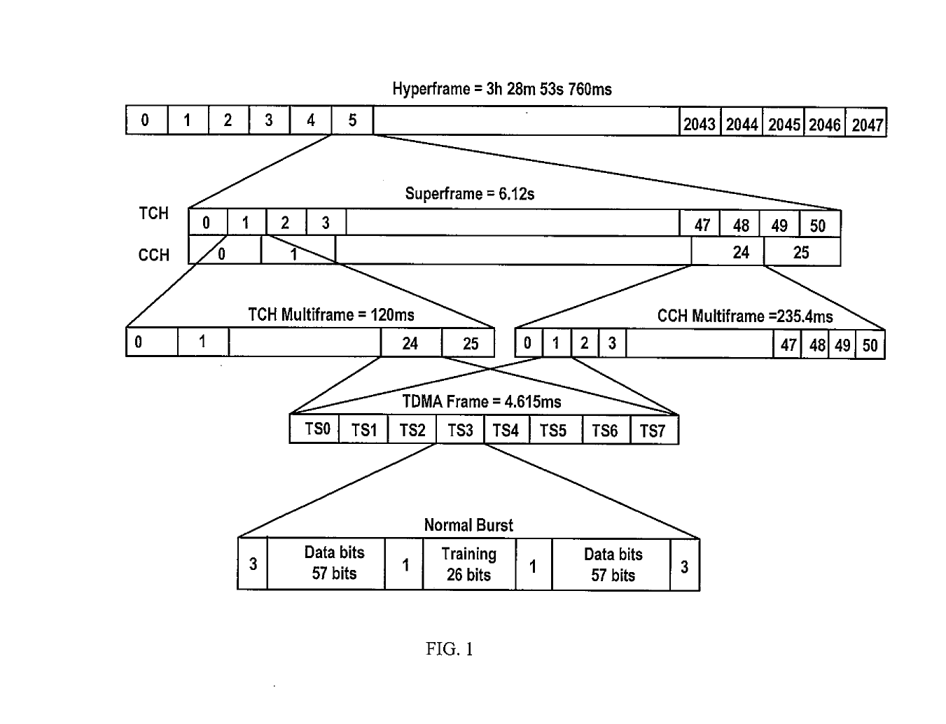

It is known that the GSM standard was designed to be a secure mobile phone system with strong subscriber authentication and over-the-air transmission encryption. In the GSM encryption algorithm, the frame number is one of variables. FIG. 1 schematically illustrates the various time segments in GSM system. As illustrated in FIG. 1, a TDMA frame comprises eight time slots TS0 to TS7, during each of which a normal burst is transmitted. Each time slot lasts 576.9 μs, and thus the duration of TDMA frame is 4.615 ms (576.9 μs×8). A Multiframe is composed of multiple TDMA frames and a Superframe is composed of multiple Multiframes. However, the Superframe consists of 1326 TDMA frames and lasts 6.12 s whether it is a CCH or TCH frame. A Hyperframe is composed of 2048 superframes, or in other word, it consists of 2715648 TDMA frames. Therefore, the hyperframe lasts 12533.76 seconds, i.e., 3 hours, 28 minutes, 53 second sand 760 milliseconds (about 3 and a half hours). Each TDMA frame is numbered according to its sequence within the hyperframe, starting from 0 and ending at 2715647.

The present inventor realizes from the above information that each TDMA frame lasts a certain time and the change of frame number means the lapse of time. Generally, the time on the base station is quite stable. The frame number is generated at base station based on the clock provided thereon and thus the frame number is quite stable and will not drift as the time on the mobile device, i.e. the local time, does.

Moreover, as mentioned above, in the GSM encryption algorithm, the frame number is one of input parameters; the base station will inform the mobile device of the frame number to decrypt the encrypted information. That is to say, the information about frame number is available for the mobile device. Therefore it is possible for the mobile device to use the frame number from a GSM network base station to count time and further for time adjustment.

Additionally, as mentioned above, the frame number will loop roughly every 3.5 hours. However, it will not cause any problem because the present invention is mainly intended to make a small change (in order of minutes, at most up to 3.5 hours) to the time on the mobile device.

The idea of the present invention is to use the frame number from a GSM network base station to count time, compare it with the time that the RTC on a mobile device is counting and adjust the latter if it seems to be drifting. Hereinbelow, detailed description of the present invention will be given based on the GSM system.

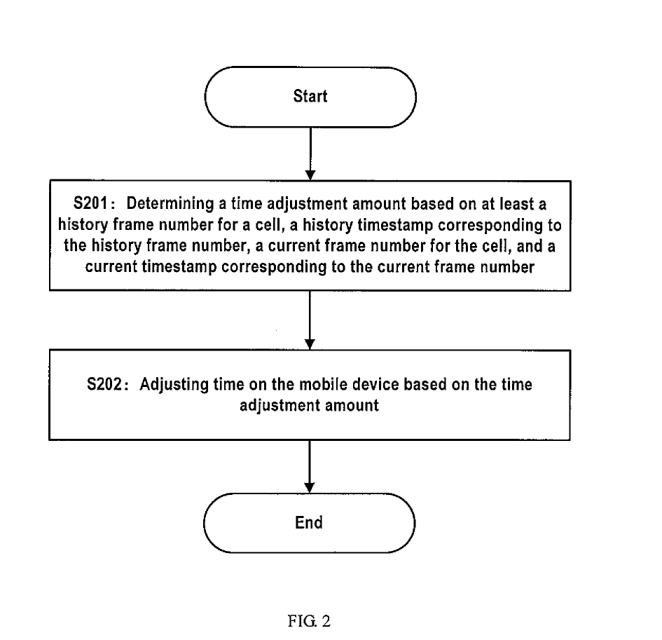

Reference is made to FIG. 2, which schematically illustrates a flow chart of a method for adjusting time according to an embodiment of the present invention.

As illustrated, at step S201, a time adjustment amount is determined based on at least a history frame number for a cell, a history timestamp corresponding to the history frame number, a current frame number for the cell, and a current timestamp corresponding to the current frame number.

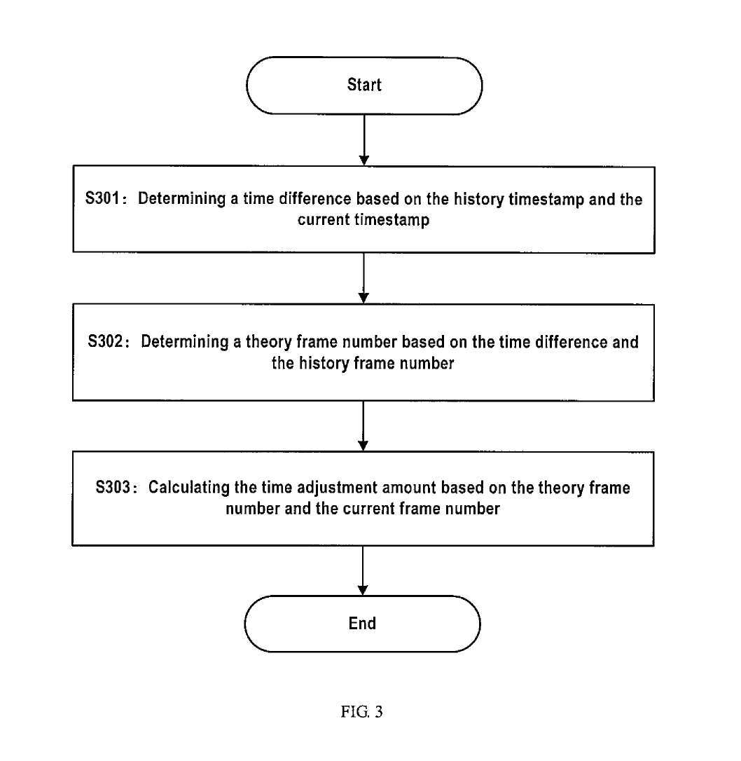

FIG. 3 schematically illustrates an embodiment of a flow chart of steps of determining a time adjustment amount according to an embodiment of the present invention.

First, at step S301, a time difference is determined based on the history timestamp and the current timestamp. During that step, time difference between two time points is determined in accordance with the time on the mobile device. Hence, it can obtain the time period after the history timestamp.

Then, at step S302, a theory frame number is determined based on the time difference and the history frame number. Based on the time difference determined in S301, it can determine how many frame numbers there are during the time period after the history timestamp. After that based on the number of frame numbers and the history frame number, the theory current frame number can be determined. Herein, the theory current frame number refers to the frame number which is expected in accordance with the time on the mobile device.

Next, at step S303, the time adjustment amount is calculated based on the theory frame number and the current frame number. The current frame number is obtained from the base station, and as mentioned above, the time on the base station is quite stable and thus the current frame number can represent a real time. The theory frame number is determined based on the time on the mobile device, it represent information about the time on the mobile device. Therefore, the difference between the theory frame number and the current frame number indicate the drift amount of time on the mobile device relative to that on the base station. The drift amount is exactly an amount that is needed to adjustment, i.e., the time adjustment amount. In such a way, the time adjustment amount can be obtained.

After the time adjustment is obtained, the time on the mobile device, i.e., the local time, can be adjusted based on the time adjustment amount at step S202. That is to say, RTC on the mobile device is adjusted by the time adjustment amount so as to keep consistence with the time on the base station.

In order to avoid too much minor adjustments, a minimum adjustment threshold can be provided. The minimum adjustment threshold can be in the order of seconds or any other suitable value. Thus, the time on the mobile device, i.e., the local time, can be adjusted when the calculated time adjustment amount is larger than the minimum adjustment threshold. The minimum adjustment threshold can be a fixed value. However, it is preferable if it is value that increases over time. Hence, the time can be adjusted more if relatively earlier timestamp and frame number information is used. In one embodiment of the present invention, the minimum adjustment threshold is a function of difference between the history timestamp and the current timestamp, which means that the larger the time difference is, the more the time can be adjusted.

In practice, the frame numbering for a given cell may be reset for a certain reason, e.g. due to electricity blackout, in such a case, frame numbers for that cell will be invalid for our purposes. Generally speaking, the time drift will not be too large, and this situation can be avoided by limiting time adjustments to small ones (in order of minutes). Therefore, it can provide a maximum adjustment threshold, for example in the order of minutes or any other suitable value. Additionally if we find invalid frame number, the information thereabout can be deleted. Thus, the local time can be adjusted when the calculated time adjustment amount is lower than the maximum adjustment threshold.

In a case that the calculated time adjustment amount is bigger than the maximum adjustment threshold, it can provide the user with an option to ask whether a bigger time adjustment is allowed. If a confirmation is received from the user, that is to say, the user allows the bigger time adjustment, the local time will be adjusted based on the time adjustment amount.

Besides, it will also probably encounter a situation that it detects a ping-pong effect, i.e., the time is adjusted back and forth frequently. The ping-pong effect is caused by, for example, history timestamps and corresponding frame numbers for two different cells, for example, when there is one minute theoretical time difference therebetween. Therefore, it may be preferable to keep track of when and how much the local time is adjusted to detect the ping-pong effect. In such a case, it can limit the frequency of the time adjustment. Therefore, in an embodiment of the present invention, the time on the mobile device is adjusted if a frequency of time adjustment is lower than a predetermined frequency threshold. Or, alternatively, if it detects a ping-pong effect, it can ask for a confirmation from the user. Thus, the time on the mobile device can be adjusted when it detects a ping-pong effect and it receives a confirmation that the time adjustment under the ping-pang effect is allowed.

Besides, it can provide the user an option so that the user can make a determination about whether the automatic time adjustment is enabled. Hence, the above method for time automatic adjustment can be performed when the automatic time adjustment setting is enabled.

In the above, the time adjustment due to time drift on the mobile device has been described; however the present invention is not limited thereto. In an embodiment of the present invention, the method can also be used for compensating the time missed because of such as battery removal. In other words, the present invention can operate at least at two modes: time drift adjustment mode and battery removal compensation mode.

It is known that, in some of mobile devices, there is provided a backup battery which will keep the time on the mobile device when the battery on the mobile device is removed or has gone flat, however if the time that the mobile device is not provided with power is too long, the backup battery will be exhausted. In such a case, the local time can only be adjusted if the time adjustment amount indicates a forward time adjustment because the local time will lag behind and will not run ahead. In this case, unlike the time drift adjustment mode, the maximum adjustment threshold can also be enlarged to for example 3.5 hours.

The frame number is specific to the base station and thus only frame numbers for a same cell are comparable. Therefore, the history frame number and the current frame number mentioned above should come from the same cell. In the present invention, there might be many chances to obtain the time stamps and corresponding frame numbers. For example, the timestamp and the corresponding frame number can be obtained at regular interval, i.e., when a predetermined time is elapsed. Additionally, or alternatively, it can be obtained when the mobile device is connected to a new cell. Another suitable chance is when the mobile device scans a base station.

Additionally, when the user adjusts the time manually, which might mean that the adjusted time should be more accurate than the previous one, it can delete all timestamps and frame numbers stored therein and obtain the new timestamp and frame number.

Besides, the history timestamp and the history frame number can also be obtained when it finds the information is not suitable for time adjustment. For example, when it detects a ping-pong effect, it can also drop the corresponding timestamp and frame number and acquire a new timestamp and a corresponding frame number. Additionally, it also can obtain a new timestamp and a corresponding frame number when the history frame number for the cell is determined as invalid, for example when the calculated time adjustment amount is bigger than the allowed maximum adjustment threshold (for example 10 minutes), which means the time adjustment amount calculated based these information is too big to use for time adjustment. Of course, the history timestamp and the history frame number can also be obtained at any other suitable and is not limited the change as listed herein.

In the following, for the purpose of illustration and easy understanding of the present invention, a specific implementation will be provided. However, it should be appreciated that the present invention is not limited thereto.

In this implementation, an entry, a set of data that includes the data is used for calculating the time difference between the theoretical and real time (i.e. for time adjustment), is stored in a database DB. The DB can be simple as a file on filesystem or in any other suitable form, and it is required to persist over reboots and battery off situations. It can only write the DB to the filesystem upon powerdown of the mobile device, or write it at a large interval (e.g., once a day). Entries, per see, are very small, and by means of such a storage manner, it will consume quite small memory.

The entry can include, for example, cell_id, location area code, time_date_stamp and frame number. The “cell_id” denotes the GSM network Cell ID. The location area code denotes a code of location area wherein the cell is located. Since the frame number is specific to a base station, each cell will have its frame number. It is known that the Cell ID may be not unique across the network, and therefore the location area code can be introduced to ensure that the entry uniquely represents information for a cell. However, it should be appreciated that the entry can be any suitable structure, as long as it includes the frame number for a certain cell and the corresponding local time. For example, the cell_id can be designed to provide all information that is required for uniquely associating the frame number, and in such as case, the location area code can be omitted.

When the mobile device connects to a new cell, for example, it will check whether an entry for cell-id of the new cell exists. If not, an entry, including the cell_id, the frame number at that time and the corresponding timestamp on the mobile device, will be added into DB. If yes, it further determines whether the entry is valid or not.

If the entry is invalid, the entry is overwritten by a new entry including the cell_id, the frame number and the corresponding timestamp. If the entry is valid, it can calculate the time adjustment amount, i.e., the time difference between theoretical time and real time and adjust the time on the mobile device based on the time adjustment amount if the time adjustment amount is larger than the minimum adjustment threshold. Of course, it also can further make other determination as mentioned above, or any other suitable determinations.

An example of time adjustment amount calculation is given as bellows.

The entry saved in DB is as follows:

Cell_id=123, timestamp_{—}1=1-Jul-2012_{—}09:43:21:098, FN=2713552.

The current timestamp and corresponding frame number when cell_id later changes to the cell with a cell_id of 123 are:

timestamp_{—}2=2-Jul-2012_{—}17:47:22:867, FN=576767

The time difference is calculated as:

Time_diff_real=(timestamp_{—}2−_timestamp_{—}1)=32 h04 m01 s769 ms=115441.769 s

Based on the time difference, the theory frame number can be calculated as:

FN_theory=(2713552+115441.769 s/0.004615 s)MOD 2715648=571540

Then in accordance with the current frame number and the calculated frame number, the time adjustment amount is calculated as:

FN_delta=FN_theory−FN_real=571540−576767=−5227=−24.123 s

In the above example, the calculated theory frame number, FN_theory, is a bit smaller FN_real and the time adjustment amount is a negative value which means that the time on the mobile device is lagging a bit behind. So it can adjust the real time clock RTC in a forward direction by 24 seconds.

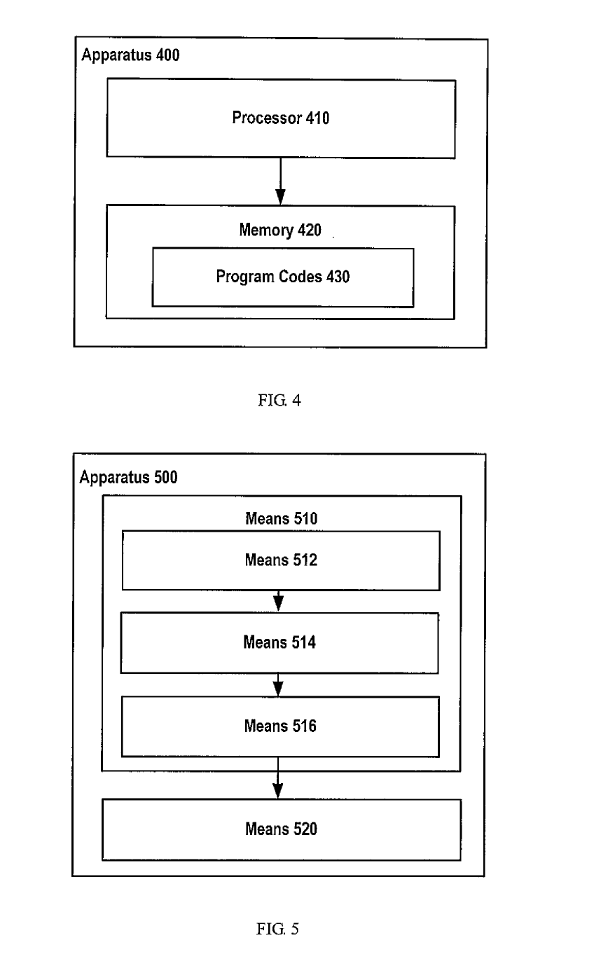

Reference is made to FIG. 4 to describe the apparatus as provided in the present invention. As illustrated in FIG. 4, apparatus 400 can comprise at least one processor 410; and at least one memory 420 including computer program code 430. Wherein, the at least one memory and the computer program code can be configured to, with the at least one processor, cause the apparatus to at least: determine a time adjustment amount based on at least a history frame number for a cell, a history timestamp corresponding to the history frame number, a current frame number for the cell, and a current timestamp corresponding to the current frame number; and adjust time based on the time adjustment amount.

Particularly, the determining a time adjustment amount can comprise determining a time difference based on the history timestamp and the current timestamp; determining a theory frame number based on the time difference and the history frame number; and calculating the time adjustment amount based on the theory frame number and the current frame number.

Before the local time is adjusted, it can first determine whether the time adjustment amount is larger than a minimum adjustment threshold. The time can be adjusted only if the time adjustment amount is larger than the minimum adjustment threshold. Preferably, the minimum adjustment threshold can be a function of difference between the history timestamp and the current timestamp. Additionally, it can further determine whether the time adjustment amount is lower than the maximum adjustment threshold, and the time can be adjusted if the result of the determination is positive.

In a case that the time adjustment amount is higher than the maximum adjustment threshold, it can provide an option to the user to ask whether a bigger time adjustment is allowed. And if it is allowed, the time is adjusted. In addition, it can also determine whether the user allows time adjustment under a ping_pong effect is allowed.

To avoid the ping-pong effect, it can also determine whether a frequency of time adjustment is lower than a predetermined frequency threshold or not. the time can be adjusted if a frequency of time adjustment is lower than the predetermined frequency threshold.

Besides, the apparatus can operate in a battery removal compensation mode. Thus, the time on the mobile device can be adjusted if the time adjustment amount indicates a forward time adjustment.

Additionally, the apparatus 400 can provide an setting option to control whether the automatic time adjustment is enabled. Thus, the apparatus 400 can be caused to perform the actions when the automatic time adjustment setting is enabled.

As mentioned hereinabove, the history timestamp and the history frame number can be obtained at one or more of when the mobile device is connected to a new cell; when the mobile device scans a base station; when a user of the mobile device adjusts the time manually; when a predetermined time is elapsed; when it detects a ping-pong effect; and when the history frame number for the cell is determined as invalid.

Next reference is made to FIG. 5 to describe another apparatus as provided in the present invention. As illustrated, apparatus 500 comprises means 510 for determining a time adjustment amount based on at least a history frame number for a cell, a history timestamp corresponding to the history frame number, a current frame number for the cell, and a current timestamp corresponding to the current frame number; and means 520 for adjusting the time based on the time adjustment amount. In an embodiment of the present invention, means 510 can further comprise means 512 for determining a time difference based on the history timestamp and the current timestamp; means 514 for determining a theory frame number based on the time difference and the history frame number; and means 516 for calculating the time adjustment amount based on the theory frame number and the current frame number. For other embodiments of apparatus 500 as provided in the present invention, which will not be detailed for a purpose of simplification, please refer to the description of apparatus 400 as described hereinabove.

It should be noted that operations of respective units as comprised in the apparatuses 400 and 500 substantially correspond to respective method steps as previously described. Therefore, for detailed operations of respective units in the apparatuses 400 and 500, please refer to the previous descriptions of the methods of the present invention with reference to FIGS. 1 to 3.

The present invention also provided a computer-readable storage media having computer program code stored thereon, the computer program code configured to, when executed, cause an apparatus to perform actions in the method as described hereinbefore. Further, there is provided a computer program product comprising a computer-readable storage media as provided in the present invention.

It should be appreciated that the above description is made based on GSM technology, however, other network technologies having similar frame numbering scheme can also be used for similar purpose. For example, in some of CDMA systems, such as original CDMA, WCDMA and TD-SCDMA, there is also similar frame numbering scheme, i.e. system frame number which are 12 bits long. Thus, the present invention may be implemented in these CDMA systems to get benefit.

In the above description, the embodiment as shown in FIG. 3 are used to describe the steps of determining the time adjustment amount; however it is provided only for the purpose of illustration and the present invention is not limited thereto. For example, it can also first determine the time difference between the history timestamp and the current timestamp, and then determine how many loops the frame number has gone. Next, the real time can be determined based on the history frame number, the current frame number, and the number of loops, and then the time adjustment amount can be determined based on the real time and the current timestamp.

By far, though the present invention has been described with reference to the currently considered embodiments, it should be appreciated that the present invention is not limited the disclosed embodiments. On the contrary, the present invention is intended to cover various modifications and equivalent arrangements falling within in the spirit and scope of the appended claims. The scope of the appended claims is accorded with broadest explanations and covers all such modifications and equivalent structures and functions.

Exemplary embodiments of the present invention have been described above with reference to block diagrams and flowchart illustrations of methods, apparatuses (i.e., systems). It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

The foregoing computer program instructions can be, for example, sub-routines and/or functions. A computer program product in one embodiment of the invention comprises at least one computer readable storage medium, on which the foregoing computer program instructions are stored. The computer readable storage medium can be, for example, an optical compact disk or an electronic memory device like a RAM (random access memory) or a ROM (read only memory).

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-25. (canceled)

26. A method, comprising
determining a time adjustment amount based on at least a history frame number for a cell, a history timestamp corresponding to the history frame number, a current frame number for the cell, and a current timestamp corresponding to the current frame number; and
adjusting time on the mobile device based on the time adjustment amount.

27. The method according to claim 26, wherein the determining a time adjustment amount comprises
determining a time difference based on the history timestamp and the current timestamp;
determining a theory frame number based on the time difference and the history frame number; and
calculating the time adjustment amount based on the theory frame number and the current frame number.

28. The method according to claim 26, wherein the time on the mobile device is adjusted if the time adjustment amount is larger than a minimum adjustment threshold.

29. The method according to claim 26, wherein the time on the mobile device is adjusted if the time adjustment amount is lower than the maximum adjustment threshold.

30. The method according to claim 29, wherein the time on the mobile device is adjusted when it receives a confirmation that a bigger time adjustment is allowed.

31. The method according to claim 26, wherein the time on the mobile device is adjusted when it detects a ping-pong effect and it receives a confirmation that the time adjustment under the ping-pong effect is allowed.

32. The method according to claim 26, wherein the time on the mobile device is adjusted if a frequency of time adjustment is lower than a predetermined frequency threshold.

33. The method according to claim 26, wherein the time on the mobile device is adjusted if the time adjustment amount indicates a forward time adjustment.

34. The method according to claim 26, wherein the history timestamp and the history frame number is obtained at one or more of:
when the mobile device is connected to a new cell;
when the mobile device scans a base station;
when a user of the mobile device adjusts the time manually;
when a predetermined time is elapsed;
when it detects a ping-pong effect; and
when the history frame number for the cell is determined as invalid.

35. An apparatus comprising:
at least one processor; and
at least one memory including computer program code;
the at least one memory and the computer program code configured to, with the at least one processor, cause the apparatus to at least:
determine a time adjustment amount based on at least a history frame number for a cell, a history timestamp corresponding to the history frame number, a current frame number for the cell, and a current timestamp corresponding to the current frame number; and
adjust time based on the time adjustment amount.

36. The apparatus according to claim 35, wherein the determining a time adjustment amount comprises
determining a time difference based on the history timestamp and the current timestamp;
determining a theory frame number based on the time difference and the history frame number; and
calculating the time adjustment amount based on the theory frame number and the current frame number.

37. The apparatus according to claim 35, wherein the time is adjusted if the time adjustment amount is larger than a minimum adjustment threshold.

38. The apparatus according to claim 35, wherein the time is adjusted if the time adjustment amount is lower than the maximum adjustment threshold.

39. The apparatus according to claim 38, wherein the time is adjusted when it receives a confirmation that a bigger time adjustment is allowed.

40. The apparatus according to claim 35, wherein the time is adjusted when it detects a ping-pong effect and it receives a confirmation that the time adjustment under the ping-pong effect is allowed.

41. The apparatus according to claim 35, wherein the time is adjusted if a frequency of time adjustment is lower than a predetermined frequency threshold.

42. The apparatus according to claim 35, wherein the time is adjusted if the time adjustment amount indicates a forward time adjustment.

43. The apparatus according to claim 35, wherein the apparatus is caused to perform the actions when the automatic time adjustment setting is enabled.

44. The apparatus according to claim 35, wherein the history timestamp and the history frame number is obtained at one or more of:
when the mobile device is connected to a new cell;
when the mobile device scans a base station;
when a user of the mobile device adjusts the time manually;
when a predetermined time is elapsed;
when it detects a ping-pong effect; and
when the history frame number for the cell is determined as invalid.

45. A non-transitory computer-readable storage media having computer program code stored thereon, the computer program code configured to, when executed, cause an apparatus to at least:
determine a time adjustment amount based on at least a history frame number for a cell, a history timestamp corresponding to the history frame number, a current frame number for the cell, and a current timestamp corresponding to the current frame number; and
adjust time based on the time adjustment amount.
